(19) United States
(12) Patent Application Publication
(10) Pub. No.: US 2014/0298462 A1
(43) Pub. Date: Oct. 2, 2014

(54) Restricted Software Automated Compliance

(71) Applicant: Sky Socket, LLC, Atlanta, GA (US)

(72) Inventors: Erich Stuntebeck, Marietta, GA (US); Himanshu Pagey, Alpharetta, GA (US)

(21) Appl. No.: 13/853,657

(22) Filed: Mar. 29, 2013

(51) Int. Cl. G06F 21/62; G06F 21/56

(52) U.S. Cl. CPC G06F 21/629; G06F 21/56
USPC 726/23; 726/30

(57) ABSTRACT

Automated restricted software compliance may be provided. Periodic scans may be performed to identify applications as potentially restricted applications. Upon identifying a restricted application, a notification of the presence of the restricted application and a proposed remedial action may be provided. If the restricted application is not removed, the remedial action may be performed.

### BACKGROUND

Automated compliance rules may be provided for handling situations where restricted software is detected on a device. Malicious software (“malware”) can appear in the form of code, scripts, active content, and other software and includes software such as computer viruses, worms, Trojan horses, rootkits, keyloggers, dialers, spyware, adware, rogue security software, and other malicious programs. Other software may be restricted by administrative or security policies. Conventional solutions often scan for malware and alert users to the threat, often allowing the threat to be contained by deleting files associated with the malware.

### SUMMARY

This Summary is provided to introduce a selection of concepts in a simplified form that are further described below in the Detailed Description. This Summary is not intended to identify key features or essential features of the claimed subject matter. Neither is this Summary intended to be used to limit the claimed subject matter's scope.

Automated restricted software compliance may be provided. Periodic scans may be performed to identify applications as potentially restricted applications. Upon identifying a restricted application, a notification of the presence of the restricted application and a proposed remedial action may be provided. If the restricted application is not removed, the remedial action may be performed.

It is to be understood that both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### BRIEF DESCRIPTION OF THE DRAWINGS

Many aspects of the present disclosure can be better understood with reference to the following diagrams. The drawings are not necessarily to scale. Instead, emphasis is placed upon clearly illustrating certain features of the disclosure. Moreover, in the drawings, like reference numerals designate corresponding parts throughout the several views. In the drawings:

FIG. 1 is a block diagram of a user device;

FIG. 2 is a block diagram of an operating environment; and

FIG. 3 is a flow chart illustrating a method for providing automated restricted software compliance.

### DETAILED DESCRIPTION

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

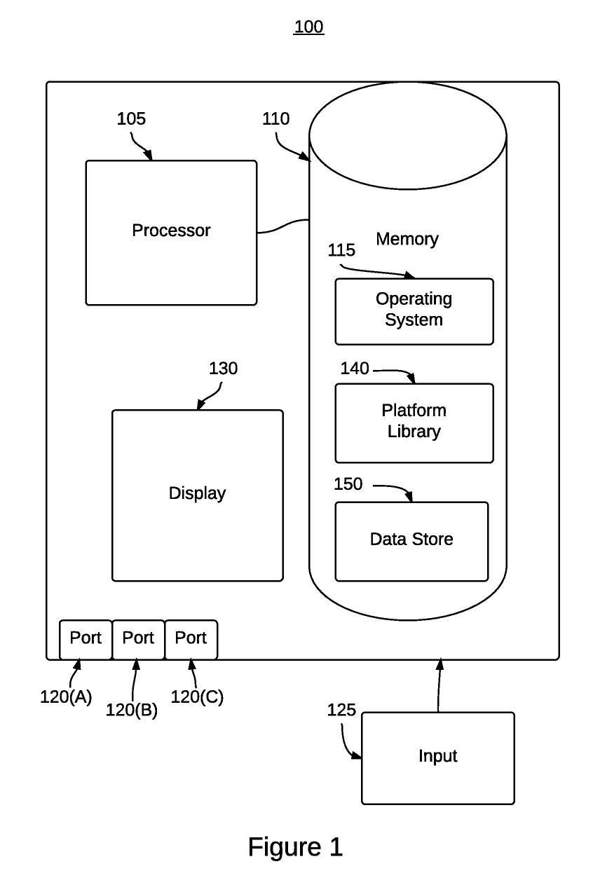

FIG. 1 is a block diagram of a user device 100 comprising a processor 105 and a memory 110. Depending on the configuration and type of device, memory 110 may comprise, but is not limited to, volatile (e.g. random access memory (RAM)), non-volatile (e.g. read-only memory (ROM)), flash memory, or any combination thereof. Memory 110 may store executable programs and related data components of various applications and modules for execution by user device 100. Memory 110 may be coupled to processor 105 for storing configuration data and operational parameters, such as commands that are recognized by processor 105. User device 100 may comprise, for example, a desktop computer, a laptop computer, a personal digital assistant, a cellular telephone, a set-top box, a music player, a web pad, a tablet computer system, a game console, and/or another device with like capability.

Basic functionality of user device 100 may be provided by an operating system 115 contained in memory 100. Various programmed software applications may be executed by utilizing the computing resources in user device 100. Applications stored in memory 110 may be executed by processor 105 (e.g., a central processing unit or digital signal processor) under the auspices of operating system 115. For example, processor 105 may be configured to execute applications such as web browsing applications, email applications, instant messaging applications, and/or other applications capable of receiving and/or providing data.

Data provided as input to and generated as output from the application(s) may be stored in memory 110 and read by processor 105 from memory 110 as needed during the course of application program execution. Input data may be data stored in memory 110 by a secondary application or other source, either internal or external to user device 100, or possibly anticipated by the application and thus created with the application program at the time it was generated as a software application program. Data may be received via any of a plurality of communication ports 120(A)-(C) of user device 100. Communication ports 120(A)-(C) may allow user device 100 to communicate with other devices, and may comprise components such as an Ethernet network adapter, a modem, and/or a wireless network connectivity interface. For example, the wireless network connectivity interface may comprise one and/or more of a PCI (Peripheral Component Interconnect) card, USB (Universal Serial Bus) interface, PCMCIA (Personal Computer Memory Card International Association) card, SDIO (Secure Digital Input-Output) card, NewCard, Cardbus, a modem, a wireless radio transceiver, and/or the like.

User device 100 may also receive data as user input via an input component 125, such as a keyboard, a mouse, a pen, a stylus, a sound input device, a touch input device, a capture device, etc. A capture device may be operative to record user(s) and capture spoken words, motions and/or gestures, such as with a camera and/or microphone. The capture device may comprise any speech and/or motion detection device capable of detecting the speech and/or actions of the user(s).

Data generated by applications may be stored in memory 110 by the processor 105 during the course of application program execution. Data may be provided to the user during application program execution by means of a display 130. Consistent with embodiments of this disclosure, display 130 may comprise an integrated display screen and/or an output port coupled to an external display screen.

Memory 110 may also comprise a platform library 140. Platform library 140 may comprise a collection of functionality useful to multiple applications, such as may be provided by an application programming interface (API) to a software development kit (SDK). These utilities may be accessed by applications as necessary so that each application does not have to contain these utilities thus allowing for memory consumption savings and a consistent user interface.

Furthermore, embodiments of this disclosure may be practiced in conjunction with a graphics library, other operating systems, or any other application program and is not limited to any particular application or system. The devices described with respect to the Figures may have additional features or functionality. For example, user device 100 may also include additional data storage devices (removable and/or non-removable) such as, for example, magnetic disks, optical disks, or tape (not shown).

User device 100 may store device and/or user-specific information in a data store 150, such as a device profile and/or a plurality of user preferences. A device profile may comprise an indication of the current position of user device 100 and/or indications of the hardware, software, and security attributes that describe user device 100. For instance, the device profile may represent hardware specifications of user device 100, version and configuration information of various software program and hardware components installed on user device 100, data transmission protocols enabled on user device 100, version and usage information of various resources stored on user device 100, and/or any other attributes associated with the state of user device 100. The device profile may further comprise data indicating a date of last virus scan of user device 100, a date of last access by an IT representative, a date of last service by the IT representative, and/or any other data indicating maintenance and usage of user device 100. Furthermore, the device profile may comprise indications of the past behavior of associated users, such as resources accessed, charges for resources accessed, and the inventory accessed from such resources. The user preferences may comprise a listing of factors that may affect the experience of the user. In particular, the user preferences may include indications of the user's age, gender, bodily traits, preferred resource types, preferred resources, and combinations thereof.

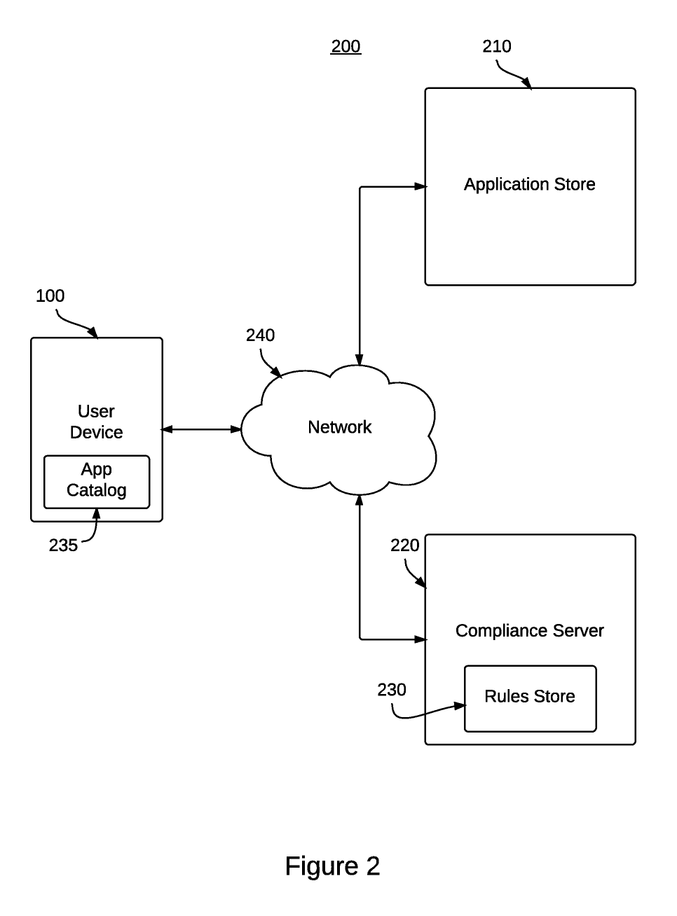

FIG. 2 is a block diagram view of an operating environment 200 comprising user device 100 in communication with an application store 210 and a compliance server 220 via a network 240. The application store 210 and compliance server 220 may comprise, for example, cloud-based solutions, server computers and/or any other system providing application distribution capability. For purposes of convenience, the application store 210 and compliance server 220 are referred to herein in the singular, although it is understood that a plurality of servers may be employed in the arrangements as descried herein. Furthermore, in some embodiments, application store 210 and compliance server 220 may operate on the same server computer. The components executed on the application store 210 and/or the compliance server 220, for example, may comprise various applications, services, processes, systems, engines, or functionality not disclosed in detail herein.

The application store 210 may comprise a digital distribution platform for application software, often provided as a component of an operating system on a personal computer, smartphone, or tablet. Application stores typically take the form of an online store, where users can browse through different categories and genres of applications (e.g., productivity, multimedia, games, etc.), view information and reviews of then, purchase it (if necessary), and then download and install the application on their device.

The compliance server may comprise a rules store 230 comprising a plurality of compliance rules that may be applicable to user device 100. Attempts by user device 100 to access various resources on user device 100 or located remotely, such as at application store 210, may require user device 100 to be in compliance with one and/or more of the compliance rules.

Depending on the sensitivity of a given resource, different compliance rules may be necessary to ensure that the resource is adequately protected. Some resources may only require ensuring that the proper user is requesting the resource. Other resources may require compliance with more stringent authorization rules, such as determining whether an appropriate transport protocol is used (i.e., http and/or https) by the requesting device, determining whether access to the resource is permitted for a specified duration or at a given time, determining whether the resource is accessed from a secured device, etc. The compliance server 220 may be operative to determine whether a pairing of the user device 100 and a specific user of user device 100 are authorized to communicate with various resources based at least in part on the compliance rules.

In some embodiments, the compliance rules may comprise application white lists comprising a listing of applications allowed to be installed and/or executed on user device 100. The compliance rules may comprise application black lists comprising a listing of applications forbidden to be installed and/or executed on user device 100. Furthermore, the compliance rules may comprise a list of functions, such as those provided by APIs associated with operating system 115 and/or platform library 140, that may be treated as protected functions. Calls to these functions, such as calls to retrieve login credentials, may result in checks for compliance with the compliance rules.

The network 240 may comprise, for example, any type of wired and/or wireless network such as a wireless local area network (WLAN), a wireless wide area network (WWAN), Ethernet, fiber-optic network, and/or any other type of wired and/or wireless network now known or later developed. Additionally, the network 110 may be or include the Internet, intranets, extranets, microwave networks, satellite communications, cellular systems, PCS, infrared communications, global area networks, or other suitable networks, etc., or any combination of such networks.

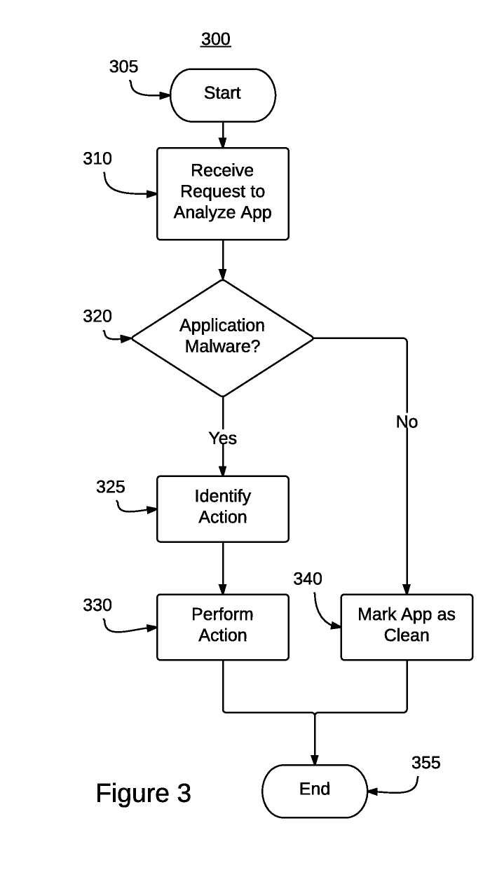

FIG. 3 is a flow chart setting forth the general stages involved in a method 300 consistent with embodiments of this disclosure for providing automated restricted software compliance. Ways to implement the stages of method 300 will be described in greater detail below. For purposes of illustration, not limitation, method 300 is described with respect to user device 100 in communication with application store 210 and/or compliance server 220. Method 300 may begin at starting block 305 and proceed to stage 310 where user device 100 may receive a request to analyze an application. For example, user device 100 may attempt to install an application from application store 210. A compliance rule may be triggered that may require the application to be analyzed prior to allowing the installation. For another example, a periodic scan may analyze a plurality of applications installed on user device 100. The scan may analyze each application and/or some applications installed on user device 100. For example, applications that have been previously analyzed and found to be in compliance with a plurality of compliance rules may not be re-scanned unless the app changes, such as being updated to a new version, and/or a new or updated compliance rule goes into effect.

From stage 310, method 300 may advance to stage 320 where user device 100 may determine whether the application comprises a restricted application or “malware”. As used herein, the terms malicious application and malware may comprise software used to disrupt computer or device operation, gather sensitive information, perform prohibited actions on user device 100, or gain access to private computer systems. Restricted software may encompass malware and/or applications controlled and/or blocked by an administrative or security policy. An application may be determined to comprise restricted software, for example, by determining that the application is on a pre-defined blacklist of applications, by determining which permissions the app seeks from the operating system 115, as certain permissions are not normally required by and/or accessible to apps, and/or by comparing a data payload associated with the app with a plurality of profiles known to indicate that an app comprises restricted software. Such data payloads may comprise, for example, a website address, author, title, email address, icon, text, user interface layout, function calls, and numerous other characteristics associated with applications. Malware applications may also be identified according to static analysis of the application's binary file, such as looking for suspicious function calls or patterns of data access, and/or dynamic analysis during execution of the application on the device and/or on a test, sandbox, and/or emulator environment. Information about the application may be retrieved from remote sources such as compliance server 220 and/or from a 3^{rd} party service that tracks and identifies malicious applications. In some embodiments, user device 100 may provide information about the app to a remote source and receive a determination as to whether the app comprises a restricted application.

If the application is determined to comprise restricted software at stage 320, method 300 may advance to stage 325 where user device 100 may identify at least one action to be performed. For example, upon first identifying the application as restricted, user device 100 may identify a compliance rule associated with notifying the user. If the app continues to be executed or stored on user device 100, or if the user persists in trying to install the app, further actions may be identified by the compliance rules. In some embodiments, these further actions may comprise escalations in their impact upon the user and/or the operation of user device 100. The at least one action to be performed may be based at least in part upon a threat level associated with the triggered compliance rule. For example, a compliance rule may simply prevent operation of a restricted app with a low threat level while another compliance rule may require removal of a medium threat level restricted app and yet another compliance rule may delete sensitive data when a high threat level restricted app is detected.

From stage 325, method 300 may advance to stage 330, where user device 100 may perform the identified action. For example, user device 100 may display a notification to a user that the application is restricted and suggest an appropriate course of action, such as uninstalling the app. User device 100 may notify the user that continuing to attempt to install, execute, or store the application on user device 100 may result in additional actions taken in accordance with a compliance rule. For example, if the app is not removed within 24 hours, access to network resources such as e-mail, web pages, etc. may be revoked. For other examples, data stored on user device may be removed and/or the device may be restored to a factory default state. Further examples may comprise limiting access to other apps and/or hardware functionality on user device 100 until the restricted app is removed and/or disabled. In some embodiments, the compliance rules may cause the user device 100 to remove the malicious application automatically, without user intervention.

If the application is determined not to comprise a restricted application at stage 320, method 300 may advance to stage 340, where user device 100 may designate the app as clean. Such a designation may be used in periodic rescans of the apps to skip apps that are known to not comprise restricted software. In some embodiments, the clean designation may be revoked upon receiving a new compliance rule or if the app is updated. Method 300 may then end at stage 355.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of this disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. The Figures above and their associated descriptions provide a discussion of a variety of operating environments in which embodiments of this disclosure may be practiced. However, the devices and systems illustrated and discussed with respect to the Figures are for purposes of example and illustration and are not limiting of a vast number of computing device configurations that may be utilized for practicing embodiments of this disclosure as described herein.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

A number of applications and data files may be used to perform processes and/or methods as described above. The aforementioned processes are examples, and a processing unit may perform other processes. Other programming modules that may be used in accordance with embodiments of this disclosure may include electronic mail, calendar, and contacts applications, data processing applications, word processing applications, spreadsheet applications, database applications, slide presentation applications, drawing or computer-aided application programs, etc.

Generally, consistent with embodiments of this disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of this disclosure may also be practiced in distributed computing environments where tasks are performed by remote processing devices that are linked through a communications network. In a distributed computing environment, program modules may be located in both local and remote memory storage devices.

Furthermore, embodiments of this disclosure may be practiced in an electrical circuit comprising discrete electronic elements, packaged or integrated electronic chips containing logic gates, a circuit utilizing a microprocessor, or on a single chip containing electronic elements or microprocessors. Embodiments of this disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of this disclosure may, for example, be implemented as a computer process and/or method, a computing system, an apparatus, device, or appliance, and/or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of this disclosure may be practiced via a system-on-a-chip (SOC) where each and/or many of the elements described above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any element may operate via application-specific logic integrated with other components of the computing device/system on the single integrated circuit (chip).

Embodiments of this disclosure are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Assignee. The Assignee retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a request to install an application;
identifying a plurality of properties associated with the application;
determining whether at least one of the plurality of properties is in violation of a compliance rule, wherein the compliance rule comprises a restricted application identifier; and
in response to determining that the at least one of the plurality of properties is in violation of the compliance rule, performing an action defined by the compliance rule.

2. The method of claim 1, wherein the performed action is further defined by the threat level associated with the compliance rule.

3. The method of claim 2, further comprising retrieving at least one restricted application identifier from a remote source.

4. The method of claim 1, wherein the plurality of properties comprise at least one of the following: a function of the application, a name of the application, a size of the application, an origin of the application, an application programming interface (API) associated with the application, and a permission request of the application.

5. The method of claim 1, wherein the performed action comprises erasing a memory location of a device.

6. The method of claim 5, wherein the memory location comprises an install location of the application.

7. The method of claim 5, wherein the memory location comprises a user data storage location.

8. The method of claim 5, wherein the memory location comprises an enterprise data storage location.

9. An apparatus comprising:
a memory storage; and
a processor coupled to the memory storage, wherein the processor is configured to:
scan a plurality of applications stored in the memory storage,
determine whether at least one of the plurality of applications comprises a malicious application,
in response to determining that the at least one of the plurality of applications comprises a malicious application, perform at least one of a plurality of remedial actions.

10. The apparatus of claim 9, wherein the processor is configured to scan the plurality of installed applications on a periodic basis.

11. The apparatus of claim 10, wherein the periodic basis comprises a configurable setting stored in the memory storage.

12. The apparatus of claim 9, wherein the processor is configured to scan the plurality of installed applications at the request of a user of the apparatus.

13. The apparatus of claim 12, wherein the user comprises an administrator.

14. The apparatus of claim 9, wherein the plurality of remedial actions comprise at least one of the following: a removal of the malicious application, a disabling of the malicious application, a disabling of the apparatus, and a notification to a user of the apparatus.

15. The apparatus of claim 14, wherein the processor is further configured to:
scan the plurality of applications stored in the memory storage again;
determine whether the at least one of the plurality of applications still comprises the malicious application, and
in response to determining that the at least one of the plurality of applications still comprises the malicious application, perform at least one escalated remedial actions.

16. The apparatus of claim 15, wherein the at least one escalated remedial action comprises at least one of the following: restoring the apparatus to a factory default condition, removing at least one non-malicious application from the apparatus, and removing a plurality of non-application data from the apparatus.

17. A computer-readable medium that stores a set of instructions that when executed performs a method executed by the set of instructions comprising:
identifying at least one of a plurality of applications as a restricted application;
determining whether the restricted application has been previously detected; and
in response to determining that the restricted application has not been previously detected, displaying a notification comprising at least one or more of the presence of the restricted application, a plurality of suggested user actions, and a plurality of potential remedial actions.

18. The computer-readable medium of claim 17, wherein the notification further comprises a time limit to remove the restricted application.

19. The computer-readable medium of claim 18, the instructions further comprising:
in response to determining that the restricted application has been previously detected, determining whether the time limit has elapsed; and
in response to determining that the time limit has elapsed, performing the remedial action.

20. The computer-readable medium of claim 17, wherein the remedial action comprises erasing a plurality of data.
